(19) United States
(12) Patent Application Publication
(10) Pub. No.: US 2026/0348318 A1
(43) Pub. Date: Nov. 5, 2026

(54) CYLINDRICAL ROTARY INTERNAL COMBUSTION ENGINE, WITH INTEGRATED COMBUSTION CHAMBERS AND EXTERNAL SIDE ACTUATORS

(71) Applicant: ARTURO VALDES RUDD, Coral Gables, FL (US)

(72) Inventor: ARTURO VALDES RUDD, Coral Gables, FL (US)

(21) Appl. No.: 19/651,661

(22) Filed: Apr. 18, 2026

Related U.S. Application Data
(60) Provisional application No. 63/791,312, filed on Apr. 18, 2025.

(51) Int. Cl. F02B 53/04; F02B 55/02

(52) U.S. Cl. CPC F02B 53/04; F02B 55/02

(57) ABSTRACT

A rotary vane engine can comprise a body with an open interior and a rotor disposed within the open interior. At least the open interior of the body can be substantially cylindrical. The rotor can have a plurality of end points, each end point configured to be proximate to an interior surface of the body. Seals can be disposed on the end points, the seals allowing for millimeters or microns of space between the end points and the interior surface. The seals can be apex seals or piezoelectric ceramic seals. A gas can enter a chamber defined between adjacent end points through an intake valve. The chamber can be arc-shaped. A first actuator can prevent exhaust gas from mixing with the intake gas. A second actuator can compress the gas in the chamber. An ignition source can induce combustion of the gas, promoting rotation of the rotor. The exhaust gas can exit through an exhaust valve.

### CROSS-REFERENCE TO RELATED APPLICATIONS

This application claims priority to and the benefit of U.S. Application Ser. No. 63/791,312, filed Apr. 18, 2025, which application is incorporated by reference in its entirety for all purposes.

### FIELD OF THE DISCLOSURE

The present disclosure relates generally to internal combustion engines and, more specifically, to a novel and efficient rotary internal combustion engine having a cylindrical geometry, integrated combustion chambers, and external side actuators.

### BACKGROUND

The evolution of the internal combustion engine, from its origins to the present day, has been dominated by traditional piston engines. These cylindrical pistons move in a reciprocating motion within another cylinder when combustion occurs. The fact that both parts are cylindrical allows for a good, long-lasting seal between the parts, in addition to facilitating production. It can be said that the cylindrical shape of the components has been its greatest strength. On the other hand, the greatest weakness of this mechanism lies precisely in the reciprocating motion of the piston as it moves within the cylinder, which must be converted into a rotary motion in order to be coupled, for example, to a vehicle's transmission, or any other of its practical applications, always based on rotation. Converting the reciprocating motion into a rotary motion involves the use of additional parts, such as the crankshaft and connecting rods, which are not part of the combustion process. This adds significant additional weight that limits the engine's efficiency and makes it more complex due to the addition of these parts. Additionally, the conversion from reciprocating to rotary motion creates constant vibrations and imbalances, limiting the engine's revolutions per minute (“rpm”). In short, the conversion of the piston's motion from reciprocating to rotary in traditional engines is its greatest limitation.

One development to solve this limitation was the rotary engine, in which the internal combustion engines are linked to a central shaft, causing it to rotate. Since there is no reciprocating motion, but rather a rotary motion, there is no need to convert the motion, and therefore, theoretically, they should be more efficient, with fewer moving parts, lighter weight, and ultimately easier to manufacture than traditional reciprocating piston engines.

There are different rotary engine designs as alternatives to the traditional piston engine. The best-known of these developments is the rotary engine designed by the German engineer Wankel, which was installed in some Volkswagen car models and later, with a more refined development, in the Japanese car brand Mazda. Although these rotary engines had a better power-to-weight ratio, less vibrations and moving parts than traditional piston engines, they have not been able to displace traditional piston engines commercially because they present design problems that have not been fully resolved, such as: (1) inefficient sealing of the combustion chambers, (2) produce high pollutant emissions, (3) poor fuel efficiency, (4) short lifespan of their parts, and (5) low torque at low rpm.

These limitations are primarily due to the complex geometry used in the body of these engines, with an eccentric central shaft geared to a rotor that does not actually rotate purely within the engine body, but rather has a complex movement that creates vibrations and hinders the sealing between its different chambers when internal combustion occurs. Additionally, the coupling between the eccentric central shaft and the rotor is achieved through gears, which introduces parasitic losses and increases the number of moving parts required for its operation. Another rotary engine developed by Liquid Piston is currently under development and testing. It addresses the challenges of the Wankel engine, achieving, thanks to its different geometry, better performance than its predecessor by achieving a compression ratio greater than 12:1, allowing the use of fuels such as diesel or any other heavy fuel, as well as the pistonless implementation of the Atkinson cycle, which improves efficiency.

Additionally, this new design offers the benefits of being a rotary engine, maintaining good energy density, low weight and size, lower vibration, and fewer moving parts. However, even this new design has not resolved some of the above-noted drawbacks of the Wankel engine, such as high emissions, poor torque, short lifespan of its components, primarily its central shaft, which, due to its design, can only use sealed bearings, limiting its lifespan to 1,000 hours, and other drawbacks in the lubrication of the apex seals and the seals used to seal its side faces.

The lubrication system in traditional engines includes additional components that are not part of the combustion process, further complicating the design and increasing manufacturing costs.

Although these rotary engine designs have achieved advances in some aspects over the traditional piston engine, they still fail to surpass them in other, crucial aspects, limiting their proliferation. The limitations they present are primarily due to the complex geometry used in the engine body, where the combustion chambers are integrated, and the need for an eccentric central shaft to transmit motion. The shape of the casing in traditional rotary engines is due to the need to house the different chambers where combustion occurs around the central rotor, the combustion interacting with the central rotor to allow the central rotor to rotate.

Rotary vane engines have also been developed and provide a design with a simpler geometry than the previous two discussed engine examples. The rotary vane engine basically comprises an elliptical engine body and a cylindrical rotor that rotates in its center, driven by internal combustion gases on the vanes it contains. The vanes rotate in conjunction with the cylindrical rotor, retracting or extending from its body and interacting with the elliptical engine body, which changes the volume of the space they create. This design allows the four events of the complete internal combustion cycle (intake, compression, combustion, and exhaust) to be performed in a single complete 360-degree rotation of the rotor. It is the most efficient internal combustion engine available, compared to a traditional Wankel rotary or piston engine, which requires several revolutions to complete the complete combustion cycle. In addition to its high intrinsic efficiency, it has the characteristics present in rotary engines, such as a good power-to-weight ratio and few moving parts. Unlike rotary engines, its parts are easier to manufacture and repair, in addition to facilitating mass production.

Two other interesting features of these motors include: (1) having a central rotor that rotates in a balanced manner so that it operates practically vibration-free, and (2) it can generate very high torque at low revolutions, something that existing rotary engines lack and that traditional piston engines can only achieve by increasing the number of pistons, an inefficient way of achieving this.

In summary, rotary vane engines have unique characteristics that significantly improve the performance of internal combustion engines developed to date. However, they have two significant problems inherent to their design, which have not yet been satisfactorily resolved, which has limited their use.

The main design drawback of rotary vane engines is linked to the physics of rotating bodies and is the so-called centrifugal force. In these engines, it is caused by the use of vanes within the cylindrical rotor. As mentioned above, these vanes are independent components that move in and out of the rotor, creating, together with the elliptical body of the engine housing, the different spaces where combustion occurs. To keep the vane tips pressed against the engine housing, sealing the different spaces they create as they rotate, the vanes are pushed outward by internal springs. This is especially necessary at low rpm, preventing the exchange of gases between the different spaces. As the rotor rpm increases, the centrifugal force generated increases proportionally, increasing the friction of the vane tips on the engine housing. This drawback leads to losses in engine efficiency, but above all, can cause a reduction in lifespan.

The other intrinsic design problem present in all rotary engine designs is the sealing between its moving parts, due to the relationship between the different geometry of the engine casing, where the combustion chambers are housed, and the central rotor that interacts with them.

Thus, current rotary vane motors exist in a form where the vanes, as independent parts, enter and exit the rotor, changing their position relative to the body of the elliptical motor as the rotor rotates. This is a primary limitation of these motors, since as the rotor rotates, its rpm increases, the centrifugal force on the vanes increases, proportionally increasing friction against the motor body that contains them. This leads to a loss of efficiency and rapid deterioration of the vanes. Additionally, the vanes of these motors require springs to keep them attached to the motor body at low rpm; to seal the compartments they form between them. These internal springs are difficult to lubricate, as are the vanes inside the rotor located in the central part of the motor. Furthermore, these motors require a guide mechanism to prevent obstructions in their movement.

Despite their limitations, rotary engines are important in the development of future internal combustion engines. The rotary vane engine offers key characteristics that make it a starting point for addressing new designs, however current rotary vane engine suffers from it's the above-noted inherent limitations.

It is to overcoming or reducing one or more of the above-described issues and limitations found with current rotary vane engines that the below described novel engine device is directed to.

### SUMMARY OF THE DISCLOSURE

A novel efficient rotary internal combustion engine device, and system and method of using same, is disclosed which, in a preferred embodiment, can be a rotary vane engine that integrates and/or incorporates piezoelectric technologies for the sealing of its combustion chambers, enhancing the rotary vane engine's performance without the need for oil lubrication.

The novel rotary internal combustion engine design described herein, can maintain the advantages of older engines, such as the rotary motion of its central shaft, a good power-to-weight ratio, few moving parts, and low vibrations, among others, while providing a new and novel approach aimed at solving or at least reducing the fundamental problems that have prevented these engines from becoming the standard compared to traditional piston engines.

The disclosed novel rotary internal combustion engine can comprise (i) a body having an opening, (ii) a rotor, (iii) two actuators, each coupled to a spring, (iv) an intake valve, (v) an electric spark, and/or (vi) an exhaust valve.

The rotor can be placed inside the opening of the body. Preferably, the body and rotor have the same geometry. As a non-limiting example, the body and rotor can both be cylindrically shaped. The rotor can also have a plurality, such as four end points, either touching the interior surface of the body or coming within millimeters or microns of touching using seals on each end point. Each end point can be equidistantly disposed from one another on the rotor.

A rotor chamber can be formed within the interior space of the body between two end points. Preferably, the rotor chamber can be arc shaped. As the rotor rotates, a gas fills the rotor chamber via an intake valve. The first actuator can be used to ensure that the exhaust gas does not mix with the gas entering through the intake valve. As the rotor chamber rotates with the rotor, the second actuator can compress the gas in the rotor chamber. Similar to the preferred four end points, the first and second actuators can either touch the rotor or come within millimeters or microns of touching using seals on the ends of each actuator.

The seals used can be apex seals or piezoelectric ceramic seals, among others and other seals now known or later developed that can be used in the space/dimensions and environment of the engine can also be used and considered within the scope of the disclosure.

After compression, the electric spark can induce combustion of the compressed gas, thereby prompting rotation of the rotor. Upon combustion, the rotor chamber's area increases, allowing for a proportional increase of the area of combustion volume. The combusted (exhaust) gas exits the rotor chamber through the exhaust valve.

In a non-limiting embodiment, the novel rotary internal combustion engine can have four rotor chambers. Each chamber is at a different stage (i.e. gas intake, compression, combustion, exhaust exit), but constant combustion at the combustion stage for or in at least one rotor chamber allows for continuous rotation of the rotor. As such, the cycle of stages can continuously repeat itself.

A novel engine is disclosed which can comprise (i) a body having an opening, (ii) a rotor, (iii) two actuators, each coupled to a spring, (iv) an intake valve, (v) an electric spark, and/or (vi) an exhaust valve. The rotor can have four end points, the rotor can be disposed inside the open interior of the body such that the four end points each touch an interior surface of the body.

The first spring causes the first actuator to touch the rotor therebetween the first and second end points of the rotor, the first actuator expanding the area of the open interior of the body between the first and second end points of the rotor as the rotor rotates.

The at least one gas enters a first section of the open interior of the body between the first and second end points of the rotor through the intake valve.

The second spring causes the second actuator to touch the rotor therebetween the first and second end points of the rotor, the second actuator compressing the at least one gas as the rotor rotates.

The electric spark induces combustion of the compressed gas.

The exhaust gas exits the first section of the open interior of the body through the exhaust valve.

In various embodiments, the engine can be configured to operate with a range of fuel types, including but not limited to gasoline, diesel, natural gas, hydrogen, biofuels, ethanol, propane, synthetic fuels, or any combination thereof. The ignition source can be an electric spark, or alternatively, the engine can be adapted for compression ignition, laser ignition, plasma ignition, or other ignition methods now known or later developed. The engine can also be configured to support various combustion cycles, including but not limited to the Otto cycle, the Diesel cycle, the Atkinson cycle, or the Miller cycle.

In further embodiments, the rotor can have a plurality of end points, such as two, three, four, five, six, or more end points, each defining corresponding rotor chambers between adjacent end points. The number of actuators can also vary, and the engine can comprise one, two, three, or more actuators, each positioned at selected angular locations around the body to regulate different phases of the combustion cycle.

The body and rotor can be manufactured from a variety of materials, including but not limited to steel, stainless steel, aluminum alloys, titanium alloys, nickel-based superalloys, ceramic matrix composites, silicon carbide composites, or combinations thereof. The selection of materials can be based on the intended operating conditions, including temperature, pressure, and rotational speed requirements.

The engine can further comprise a cooling system, which can be an air-cooled system, a liquid-cooled system, an oil-cooled system, or a combination thereof. The cooling system can be integrated into the body, the rotor, or both, to manage thermal loads during operation.

The engine can be scalable and can be configured for a variety of applications, including but not limited to automotive propulsion, marine propulsion, aviation propulsion, unmanned aerial vehicle (UAV) propulsion, power generation, industrial equipment, hybrid vehicle range extension, or portable power applications.

A non-limiting embodiment for a rotary internal combustion engine can preferably comprise: (1) a body can define an open interior, (2) a rotor can be disposed inside the open interior of the body, the rotor can have a plurality of end points, wherein each end point can be configured to be proximate to an interior surface of the body, (3) at least one chamber can be defined between adjacent end points on an exterior surface of the rotor, (4) a first actuator can be disposed within the body, (5) a second actuator can be disposed within the body, (6) an intake valve can be configured to admit at least one gas into the at least one chamber, (7) an exhaust valve can be configured to discharge exhaust gas from the at least one chamber, and (8) an ignition source can be configured to induce combustion of a compressed gas within the at least one chamber. The first actuator can be configured to separate an intake region from an exhaust region within the open interior. The second actuator can be configured to compress the at least one gas within the at least one chamber as the rotor rotates.

A non-limiting embodiment for a method of operating a rotary internal combustion engine can preferably comprise: (1) rotating a rotor within a body that can define an open interior, the rotor can have a plurality of end points and at least one chamber can be defined between adjacent end points, (2) admitting at least one gas into the at least one chamber through an intake valve as the rotor rotates, (3) separating an intake region from an exhaust region within the open interior using a first actuator, (4) compressing the at least one gas within the at least one chamber using a second actuator as the at least one chamber moves past the second actuator during rotation of the rotor, (5) inducing combustion of the compressed gas within the at least one chamber using an ignition source, thereby generating a force that can be configured to promote continued rotation of the rotor, and (6) discharging exhaust gas from the at least one chamber through an exhaust valve.

A non-limiting embodiment for a rotary engine system can preferably comprise: (1) a substantially cylindrical body can define an open interior, (2) a rotor can be disposed within the open interior of the body, the rotor can comprise a plurality of end points and a plurality of arc-shaped chambers that can be defined between adjacent end points, wherein the plurality of end points can comprise vanes that can be monolithically formed as an integral part of the rotor, (3) a first actuator and a second actuator that can each be disposed within the body, each actuator can be coupled to a respective spring, the first actuator can be configured to separate an intake region from an exhaust region and the second actuator can be configured to form a wall within at least one of the plurality of arc-shaped chambers to compress a gas within at least one of the plurality of arc-shaped chambers, wherein the second actuator can constantly be changing such that the wall can shrink an internal area of the at least one of the plurality of arc-shaped chambers as the rotor rotates, (4) at least one seal can be disposed on at least one of the plurality of end points, and (5) an ignition source can be configured to induce combustion of the compressed gas.

### BRIEF DESCRIPTION OF DRAWINGS

FIG. 1 illustrates a perspective view of a first non-limiting embodiment for the novel engine device of the current disclosure;

FIG. 2 illustrates a front view of the engine device of FIG. 1;

FIG. 3 illustrates a front view of the novel engine device of FIG. 1 shown having seals;

FIG. 4 illustrates a first front cross-sectional view of the novel engine device of FIG. 1;

FIG. 5 illustrates a second front cross-sectional view of the novel engine device of FIG. 1;

FIG. 6 illustrates a third front cross-sectional view of the novel engine device of FIG. 1;.

FIG. 7 illustrates a fourth front cross-sectional view of the novel engine device of FIG. 1;

FIG. 8 illustrates a fifth front cross-sectional view of the novel engine device of FIG. 1;

FIG. 9 illustrates a front view of the novel engine device of FIG. 1;

FIG. 10A illustrates a front view of the novel engine device of FIG. 1;

FIG. 10B illustrates a front view of the novel engine device of FIG. 1;

FIG. 11 illustrates a front cross-sectional view of the novel engine device of FIG. 1 shown having seals; and

FIG. 12 illustrates an exploded perspective view of the engine device of FIG. 1.

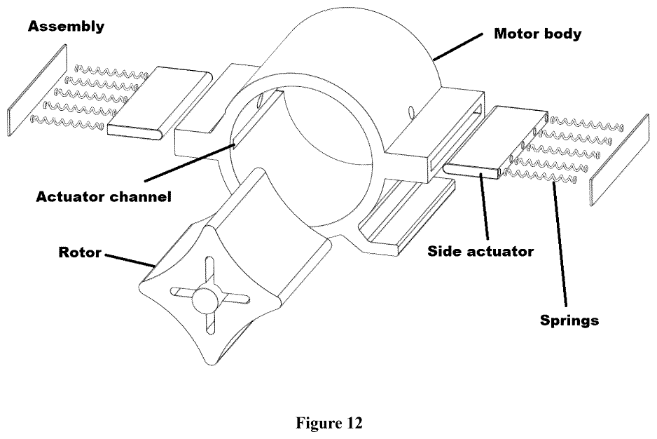

### DETAILED DESCRIPTION OF THE DISCLOSURE

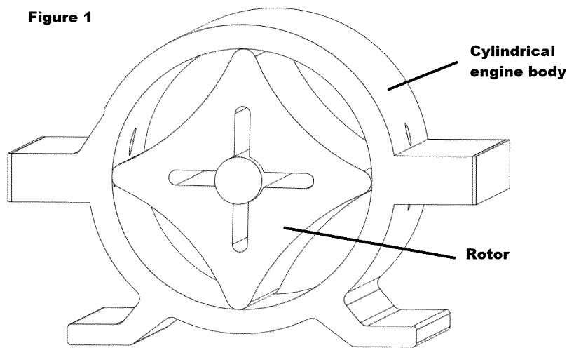

The novel engine device disclosed herein, and system and method of using same, can consist of two cylinders inside each other, where the engine body and rotor can be preferably cylindrical in shape The rotor's motion can be rotary. This geometry of the novel design can allow for better sealing between the different chambers involved in the combustion cycle, which has been one of the major problems faced by prior rotary engine designs to date, due to the different geometry of its parts. However, in the novel engine device, the engine body (stator) can be cylindrical, housing a rotor that can also be cylindrical in shape, which would contain the different chambers that make the complete combustion cycle possible, which enables its rotation (FIG. 1).

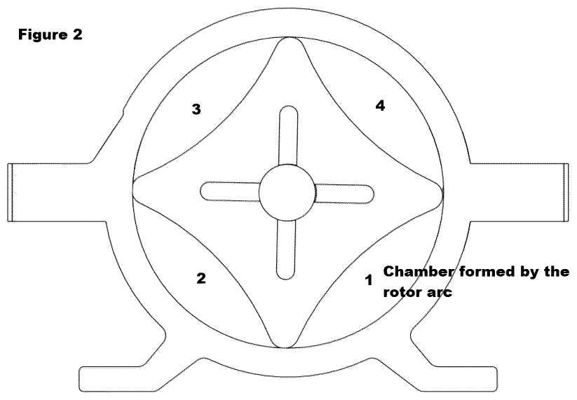

The rotor chambers can be arc-shaped around the rotor's external diameter. In a non-limiting embodiment, a rotor design can have four integrated chambers. The cylindrical rotor can have on its periphery, four roughly shaped volumetric areas in the shape of an arc. The volumetric areas can be equidistant from each other, where the center of each arc can be the point of shortest distance from the rotor's center and at the same time the furthest from its circumference. Within the 360 degrees of the rotor's circumference, the center of the first arc can be at roughly 0 degrees, the center of the second can be at roughly 90 degrees, the third can be at roughly 180 degrees, being one arc symmetrical on the opposite side of the first arc, and finally the fourth arc can have its center at roughly 270 degrees, the arc being in a symmetrical position to the second arc (FIG. 2).

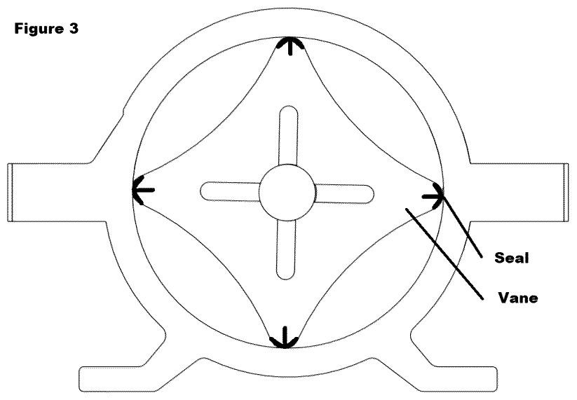

The arcs can be arranged symmetrically to achieve a balanced rotor mass, eliminating vibrations during combustion cycles. Between the end of one arc and the beginning of the next, tips form on the rotor's cylindrical body, separating the spaces between the arcs. These tips are effectively vanes, which (as disclosed below) can assist in the internal combustion cycles when the rotor rotates. The tips of the vanes can touch, within a certain tolerance, the inner surface/diameter of the cylinder containing the rotor, delimiting the area of the four different arcs. To effectively seal the spaces between the different arcs, so that the gases formed during the combustion cycle do not pass from one arc/chamber to the other, seals can be placed at the tips of the vanes. These seals can be apex seals or another innovative solution, such as but not limited to the use of piezoelectric ceramics, which can regulate the distance in microns or millimeters from the tip of the vane to the cylinder/cylinder inner surface (FIG. 3). This geometry enables a better seal between the cylinder and the rotor.

As mentioned, in this design, the vanes can be monolithically formed and/or constructed as an integral part of the rotor and the vanes can be non-movable and do not need to cover a specific distance from the cylindrical body containing the rotor. As such, limitations of traditional rotary vane motors, where the vanes, as independent parts, enter and exit the rotor, changing their position relative to the body of the elliptical motor as the rotor rotates can be overcome. The disclosed novel engine device, however, does not require moving vanes, as these are preferably an integral part of the rotor, as are the combustion chambers. As such, the novel engine device can have fewer moving parts, simplifying existing rotary engine designs, which already have fewer parts than traditional piston engines.

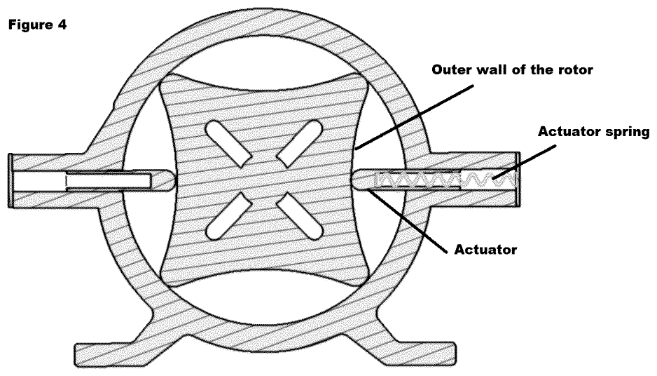

In a non-limiting embodiment, the combustion chambers and vanes can be an integral part of the rotor. In this preferred design, two external actuators can be integrated into the engine's cylindrical body to induce the internal combustion process. Though not limiting, the pair of actuators can be placed symmetrically on either side of the engine body in the plane of its central axis. In a non-limiting embodiment, the pair of actuators can be vane-shaped actuators, similar to those used by rotary vane rotors. The pair of actuators can be pushed toward the central rotor by springs also located in the engine body, preferably outside the cylinder and rotor. This non-limiting configuration can allow for easy lubrication of the springs and the pair of actuators and can prevent exposure to high temperatures present in the combustion chamber, inside the cylinder. The lubrication can be external. The actuators can enter through slits in the central cylindrical cavity of the engine where the rotor is housed and can press against its outer periphery with seals at their tips. As the rotor rotates, the actuators can move around the rotor's perimeter, forming different, sealed spaces in the geometry of the arc-shaped cavities present on the rotor's external surface. (FIG. 4)

In the preferred, though non-limiting, embodiment, two actuators can be used to regulate a complete combustion cycle, equivalent to a 360-degree rotation of the rotor.

A first actuator can be located in the engine's cylindrical body at 0 degrees from its center plane. The first actuator forms a wall that, with the help of a seal at its tip, can divide and separate the intake and exhaust ports located below and above the actuator, respectively, preventing the intake and exhaust gases from mixing when the rotor rotates.

A second actuator can be located 180 degrees from the center plane of the engine body, symmetrical to the first actuator. The second actuator can regulate the compression and combustion cycles by forming a wall within the rotor's arc-shaped chambers. By way of non-limiting embodiment, the arc-shaped chambers can rotate together with the rotor. Through this form of rotation, the size of the wall formed by the second actuator and arc-shaped chambers can constantly be changing. As the wall shrinks, the chamber's internal area decreases, which can promote compression of the gas in the chamber. Subsequently, when the compressed gas mixes with the fuel, an electric spark can be used to induce combustion. Thereafter, the gas can expand against the wall of the actuator in the chamber area, which can promote rotation of the rotor.

A non-limiting example of how the disclosed novel engine device can operate can be exemplified through the combustion cycle shown below.

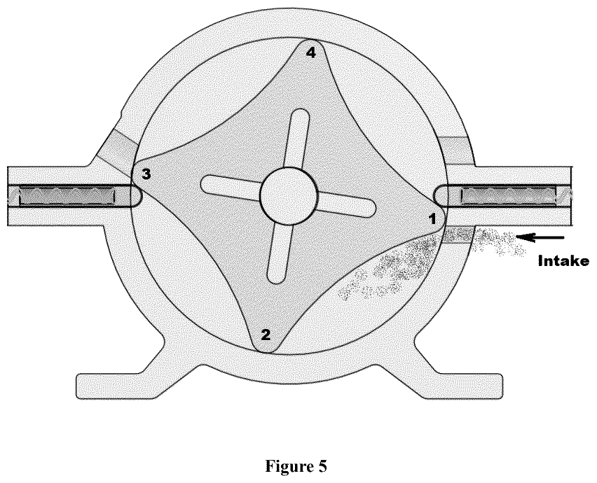

The central rotor can begin to rotate due to the force of ignition, the pointed tips at the ends of its cavities can act as vanes that rotate with the central rotor, drawing in outside air through the open intake inlet in the engine's cylindrical body, preferably located just below the first actuator. The outside air can enter the arc-shaped rotor cavity below, completing the Intake Cycle (FIG. 5).

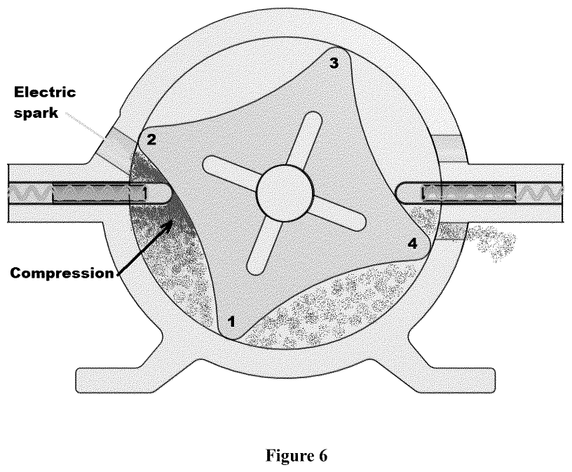

The rotor cavity with the air inside can continue to rotate, and the second actuator, located 180 degrees from the first actuator, can progressively enter the rotor cavity. Since the cavity has an arc-shaped area, as it continues to rotate closer to the actuator wall, its space can be reduced, compressing the air it carries, completing the Compression Cycle (FIG. 6).

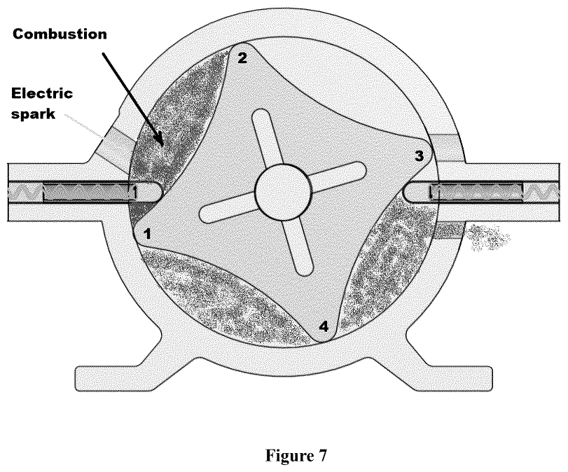

Once the end of the arc passes the actuator responsible for regulating the compression and combustion cycles, the spark that produces combustion can be induced. As the air-fuel mixture expands between the actuator wall and the surrounding area of the arc-shaped cavity, a thrust can be created in the direction of arc-shaped cavities tip, creating a rotational torque that causes the rotor to rotate. As the rotor rotates, the cavity area increases, proportionally increasing the area of the combustion volume and completing its Combustion cycle (FIG. 7).

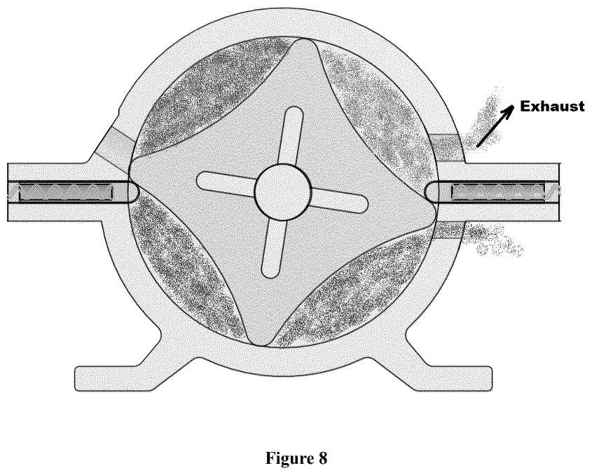

The cavity containing the combustion gas can continue to rotate, along with the rotor, and before completing a full 360-degree rotation, the cavity containing the combustion gas can expel the gas to the outside through the exhaust port located just above the first actuator, which is responsible for preventing the exhaust gas from mixing with the intake air. When the rotor cavity passes the actuator, it finishes expelling the residual combustion gases, completing the Exhaust Cycle (FIG. 8).

As can be seen, each full 360-degree rotation can complete the above-described four events of the combustion cycle within the chambers the novel engine device integrates.

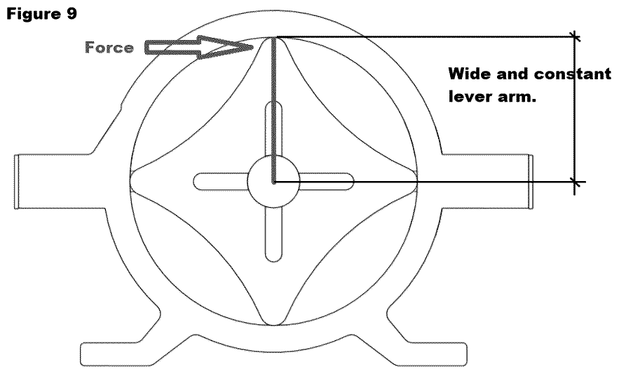

The novel engine device can also create a good, continuous rotational torque due to the combustion force on the tip of the arc-shaped cavity, which can project a lever arm toward the center of the rotor, where the torque is produced (FIG. 9). Additionally, in one non-limiting embodiment, the lever arm preferably never changes its position relative to the combustion force throughout the entire combustion event, which can allow for a very broad torque peak that lasts practically the entire combustion event. Since the rotor can have multiple cavities, the end of one combustion event can be the beginning of a new one, allowing for good, continuous torque with each 360-degree rotation of the rotor.

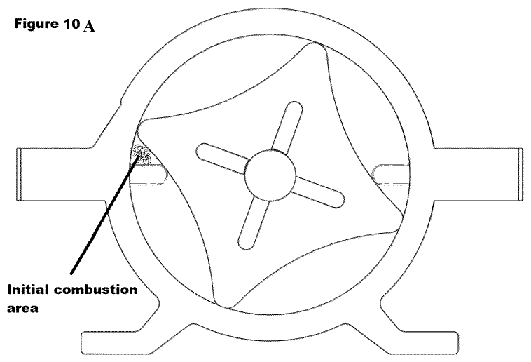

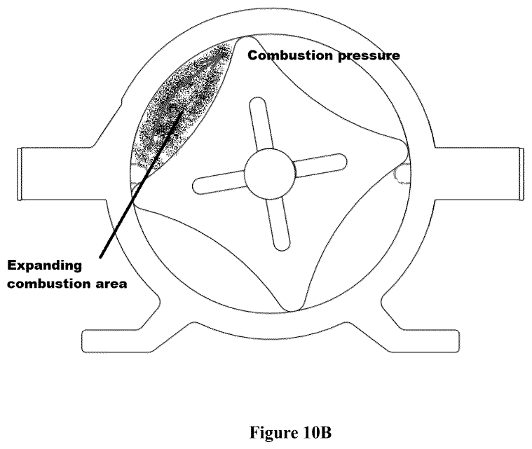

Another strength of the novel engine device can be its energy efficiency, due to the progressive increase in space in the arc-shaped cavities as the central rotor rotates. When the combustion cycle begins, the initially small space where the spark is produced expands due to the combustion force, causing the rotor and its chambers to rotate together. As the chamber rotates, its arched geometry increases the volume of air inside, maximizing combustion and achieving better energy transfer, which can create greater efficiency in the combustion cycle (FIGS. 10A, 10B).

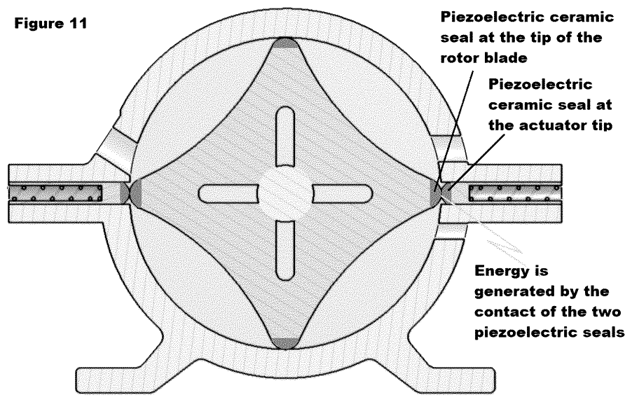

By having a rotor design with integrated fixed blades that can maintain a minimal tolerance with the cylindrical body of the motor (stator), by way of non-limiting embodiment, it is feasible to place piezoelectric seals at the tips of the blades to regulate this small tolerance. This solution can also be applied to the tips of the two actuators by placing piezoelectric seals that can adjust their separation as they move along the surface of the rotor (FIG. 11).

The use of piezoelectric seals in the novel engine device can bring significant benefits, as the absence of friction between the motor's moving parts eliminates the need for lubricants. This, in turn, can simplify the system by removing the requirement for a lubrication system, unlike conventional motors.

Another significant benefit of the interaction between the different components containing piezoelectric seals is the possibility of turning the motor into a self-generating electricity system, as explained below:

By adding a piezoelectric seal at the tip of the actuator, which interacts with the piezoelectric seals at the tips of the blades, energy can be generated during rotation due to the interaction between the piezoelectric components (i.e. energy can be generated by the contact of the two piezoelectric ceramic seals-one at the tip of the rotor blade and one at the actuator tip).

The novel device can have the following basic principles of interaction. When the piezoelectric ceramics at the tips of the blades pass close to the piezoelectric strip at the actuator's tip during rotation, two key effects can occur: (1) a direct piezoelectric effect, and/or (2) an inverse piezoelectric effect. For the direct piezoelectric effect, the pressure or vibration generated by the close contact can induce an electric charge in the piezoelectric ceramics. This effect can be harnessed to generate electrical energy. For the inverse piezoelectric effect, voltage can be applied to one of the piezoelectric ceramics, which can allow a controlled deformation to be generated. Preferably, the voltage can be applied at the blade tips or at the actuator tip. Thus, the inverse piezoelectric effect can actively adjusting the tolerance of the piezoelectric components in real-time.

By way on various non-limiting examples, the device's design can have the following applications: (1) dynamic and synchronized tolerance adjustment, (ii) electrical energy generation, and/or (3) monitoring vibrations and dynamic conditions.

In terms of dynamic and synchronized tolerance adjustment, the piezoelectric seal at the actuator tip can function as both a proximity sensor and an actuator. When the blade tips pass near the actuator, a signal can be sent to the control system to (i) actively adjust the blade tips (i.e., via the inverse piezoelectric effect) and/or (ii) dynamically regulate the separation between components, which can maintain optimal tolerance. Thus, the device can allow for extreme precision in tolerance, which can, preferably instantly, compensate for thermal expansion, vibrations, and/or misalignments.

For electrical energy generation, when the piezoelectric seals at the blade tips pass by the piezoelectric seal on the actuator, vibrations or airflow/combustion near the surface can cause small deformations. These deformations can exploit the direct piezoelectric effect to generate a small amount of electrical energy. The generated energy can be used for (i) powering sensors within the system, (ii) providing feedback to the ceramic control system, and/or (iii) integrating as an auxiliary power system.

To further describe monitoring vibrations and dynamic conditions, the piezoelectric seal on the actuator can act as a vibration sensor. Each time the blades pass near the strip, the generated electrical signal can provide information on (i) blade misalignment, (ii) tolerance variations, and/or (iii) operational anomalies (e.g., excessive vibrations, wear, etc.).

By adding a piezoelectric seal to the actuator tips and momentarily aligning them with the piezoelectric seals on the rotor blade tips during rotation, the following non-limiting and non-exhaustive benefits can be achieved: (1) active tolerance adjustment between the blades and the actuator, (2) electrical energy generation, and/or (3) real-time monitoring of dynamic conditions.

The active tolerance adjustment between the blades and the actuator can preferably use the inverse piezoelectric effect for extreme precision. This adjustment can be used for modifying the tolerance to regulate the fuel-air mixture at the start of the combustion cycle. The device can preferably use the direct piezoelectric effects by leveraging the blade motion to achieve electrical energy generation. Furthermore, preferably through the generated electrical signals, the device can perform real-time monitoring of dynamic conditions such as, but not limited to, vibrations and/or misalignments.

This integration can enable the development of a self-adjusting, efficient, and real-time monitored system.

Additionally, piezoelectric strips can be added to the cylindrical body of the motor (stator) to enhance the motor's electrical generation by interacting with the piezoelectric seals on the rotor tips, in the same manner previously described for the actuator's piezoelectric seals.

In summary, the novel engine device can have the following non-limiting advantages, benefits, features and/or characteristics among others: (1) a preferred cylindrical geometry of at least certain of its components facilitates the sealing between the engine body and the central rotor, (2) few moving parts facilitate manufacturing, assembly, and repair, (3) high energy density, (4) low weight, (5) high fuel efficiency, (6) low polluting emissions, (7) high longevity of its parts, (8) high torque at low and high rpm, (9) very low vibration during operation, (10) possibility of self-generated energy, resulting from the interaction of the various piezoelectric components, and/or (11) does not require a lubrication system.

By way of non-limiting example, A rotary vane engine comprising a body with an open interior and a rotor. At least the open interior of the body can be cylindrical. The rotor can be disposed within the open interior. The rotor can have four end points, each end point can be disposed equidistant from each other. The end points can be naked or have seals, the seals allowing for millimeters or microns of space between the end points and an interior surface of the body. The seals can be apex seals or piezoelectric ceramic seals. A gas enters a first section of the open interior between the first end point and the second end point through an intake valve. The first section of the open interior can be arc shaped. A first actuator prevents exhaust gas from mixing with the gas. A second actuator compresses the gas in the first section of the open interior. An electric spark induces combustion of the gas, propelling rotation of the rotor. The exhaust gas exits through an exhaust valve, before the cycle repeats.

In various embodiments, the body of the engine can be constructed from materials selected based on the intended operating environment and performance requirements. By way of non-limiting example, the body can be manufactured from cast iron, carbon steel, stainless steel, aluminum alloys such as A356 or 6061, titanium alloys such as Ti-6Al-4V, nickel-based superalloys such as Inconel 718, ceramic matrix composites, silicon carbide composites, or combinations thereof. The rotor can similarly be manufactured from any of the foregoing materials, or from different materials than the body, depending on the thermal and mechanical loading conditions. In some embodiments, the rotor and body can be manufactured from dissimilar materials to optimize the thermal expansion characteristics, weight, and strength of each component independently.

The seals described herein are not limited to apex seals and piezoelectric ceramic seals. In alternative embodiments, the seals can comprise labyrinth seals, brush seals, carbon seals, polymer seals, spring-loaded metallic seals, gas-film seals, magnetic seals, or any combination thereof. The selection of seal type can be based on the operating temperature, pressure differential, rotational speed, and desired maintenance interval. In certain embodiments, a hybrid sealing approach can be employed, wherein different seal types are used at different locations within the engine. For example, piezoelectric ceramic seals can be used at the rotor end points while spring-loaded metallic seals can be used at the actuator tips, or vice versa.

The engine can be configured to operate with a variety of fuel types. In non-limiting embodiments, the engine can operate on gasoline, diesel fuel, natural gas, compressed natural gas (CNG), liquefied natural gas (LNG), hydrogen, biofuels, ethanol, methanol, propane, butane, synthetic fuels, dimethyl ether, ammonia, or any combination or blend thereof. The fuel delivery system can comprise a carburetor, a port fuel injection system, a direct fuel injection system, or a combination thereof. In embodiments utilizing hydrogen as a fuel, the engine can be configured with appropriate materials and sealing to accommodate the properties of hydrogen gas.

The ignition source described herein as an electric spark is non-limiting. In alternative embodiments, the ignition source can comprise a conventional spark plug, a multi-spark ignition system, a compression ignition system (for use with diesel or heavy fuels), a laser ignition system, a plasma ignition system, a microwave-assisted ignition system, a pre-chamber ignition system, or any other ignition method now known or later developed. In embodiments configured for compression ignition, the compression ratio of the engine can be adjusted by modifying the geometry of the arc-shaped chambers to achieve the required compression ratio for auto-ignition of the fuel-air mixture. The engine can also be configured to support various combustion cycles, including but not limited to the Otto cycle, the Diesel cycle, the Atkinson cycle, or the Miller cycle.

In further embodiments, the engine can be coupled to a turbocharger, a supercharger, an electric supercharger, or any combination thereof, to increase the mass of intake air or air-fuel mixture delivered to the rotor chambers. The increased charge density can result in higher power output from the engine without increasing its physical size. The engine can also incorporate variable intake and exhaust timing mechanisms to optimize performance across a range of operating speeds and loads.

The engine can further comprise a cooling system integrated into the body, the rotor, or both. In non-limiting embodiments, the cooling system can be an air-cooled system utilizing fins on the exterior of the body, a liquid-cooled system utilizing coolant passages within the body and/or rotor, an oil-cooled system, or a combination thereof. In certain embodiments, the cooling system can incorporate a thermostat, a coolant pump, a radiator, and associated plumbing to maintain the engine within a desired operating temperature range. The cooling system can be integrated into the body, the rotor, or both, to manage thermal loads during operation.

In non-limiting embodiments, the engine can further comprise an electronic control unit (ECU) or engine control module (ECM) configured to monitor and control various engine parameters. The ECU can receive input signals from one or more sensors, including but not limited to temperature sensors, pressure sensors, rotational speed sensors, position sensors, oxygen sensors, knock sensors, and the piezoelectric sensors integrated into the seals. Based on the input signals, the ECU can control the ignition timing, fuel injection timing and quantity, actuator position, and other engine operating parameters to optimize performance, efficiency, and emissions.

The engine disclosed herein can be scalable across a wide range of sizes and power outputs. In non-limiting embodiments, the engine can be configured as a micro-engine for use in unmanned aerial vehicles (UAVs), model aircraft, or portable power generation, having a displacement on the order of cubic centimeters. Alternatively, the engine can be scaled to larger displacements for use in automotive, marine, aviation, industrial, or stationary power generation applications. The engine disclosed herein can also be configured for portable power applications. The scalability of the engine can be facilitated by the simplicity of its cylindrical geometry and the reduced number of moving parts compared to traditional piston engines.

In certain embodiments, multiple engines as disclosed herein can be arranged in series along a common output shaft to increase total power output while maintaining the advantages of the individual engine units. Alternatively, a single engine body can house multiple rotors on a single shaft, each rotor having its own set of chambers and actuators, to achieve increased displacement and power output within a compact package.

The engine can be coupled to a variety of output systems, including but not limited to a mechanical transmission (manual, automatic, or continuously variable), an electrical generator for hybrid or series-hybrid propulsion, a propeller shaft for marine or aviation applications, a hydraulic pump, or any other power-consuming device. In hybrid vehicle applications, the engine can function as a range extender, providing electrical energy to charge a battery pack while an electric motor provides primary propulsion.

The manufacturing of the engine components can be accomplished through a variety of methods, including but not limited to CNC machining, casting (sand casting, investment casting, die casting), forging, powder metallurgy, additive manufacturing (3D printing), electrical discharge machining (EDM), or combinations thereof. The arc-shaped chambers on the rotor can be formed by machining, casting, or additive manufacturing processes. The tight tolerances between the rotor end points and the body interior surface can be achieved through precision grinding, honing, lapping, or other finishing processes.

The body and rotor can be manufactured from a variety of materials, including but not limited to steel, stainless steel, aluminum alloys, titanium alloys, nickel-based superalloys, ceramic matrix composites, silicon carbide composites, or combinations thereof. The selection of materials can be based on the intended operating conditions, including temperature, pressure, and rotational speed requirements.

In embodiments where the engine is configured for operation without a dedicated lubrication system (such as when piezoelectric seals are employed to maintain non-contact operation between the rotor and body), the engine can achieve reduced parasitic losses, simplified construction, reduced weight, and reduced maintenance requirements compared to engines requiring oil lubrication. In alternative embodiments where some lubrication is desired, the engine can incorporate a minimal lubrication system, such as an oil mist system or a metered oil injection system, to provide lubrication to the actuator springs and/or other components that may benefit from lubrication.

The engine can further comprise one or more sensors for monitoring the condition of the seals, the actuators, the rotor, and the body during operation. In non-limiting embodiments, the piezoelectric elements integrated into the seals can serve a dual function as both sealing elements and sensors, providing real-time data on seal condition, gap distance, vibration levels, and temperature. This sensor data can be communicated to the ECU for use in adaptive control strategies and predictive maintenance algorithms.

In certain embodiments, the exhaust gases exiting the engine through the exhaust valve can be directed to a catalytic converter, a particulate filter, a turbocharger turbine, a waste heat recovery system, or any combination thereof, to reduce emissions and/or recover additional energy from the exhaust stream. The engine can be configured to meet or exceed applicable emissions standards, including those set by governmental regulatory agencies.

In further embodiments, the rotor can have a plurality of end points, such as two, three, four, five, six, or more end points, each defining corresponding rotor chambers between adjacent end points. The number of actuators can also vary, and the engine can comprise one, two, three, or more actuators, each positioned at selected angular locations around the body to regulate different phases of the combustion cycle.

In one exemplary embodiment, the engine can comprise a body having an open interior, a rotor having four end points, the rotor disposed inside the open interior of the body such that the four end points can each touch an interior surface of the body. A first actuator can be disposed inside the body and coupled to a first spring, and a second actuator can be disposed inside the body and coupled to a second spring. The engine can further comprise an intake valve, an exhaust valve, and an electric spark. The first spring can cause the first actuator to touch the rotor between the first and second end points of the rotor, the first actuator being adapted to expand the area of the open interior of the body between the first and second end points of the rotor as the rotor rotates. A first section of the open interior of the body can be adapted to receive at least one gas entered through the intake valve between the first and second end points of the rotor. The second spring can cause the second actuator to touch the rotor between the first and second end points of the rotor, the second actuator being adapted to compress the at least one gas as the rotor rotates. The electric spark can be adapted to induce combustion of the compressed gas, and the first section of the open interior of the body can be adapted to exit exhaust gas through the exhaust valve. In this embodiment, the open interior of the body can be cylindrical in shape, and the rotor at its outer end points can define a cylindrical perimeter. The at least one gas can be air. The first actuator and the second actuator can be disposed about 180 degrees apart from each other inside the body. Each of the four end points can be disposed about 90 degrees apart from each other. An outer perimeter of the rotor from the first end point to the second end point can be substantially arc-shaped and can cause the adjacent outer perimeter of the first section of the open interior of the body to be substantially arc-shaped.

In another exemplary embodiment, the engine can comprise a body having an open interior, a rotor having four end points, the rotor disposed inside the open interior of the body, and four seals, one seal disposed on each end point of the rotor, such that the four end points of the rotor can each be within millimeters or microns of touching an interior surface of the body. A first actuator can be disposed inside the body and coupled to a first spring, and a second actuator can be disposed inside the body and coupled to a second spring. The engine can further comprise an intake valve, an exhaust valve, and an electric spark. The first spring can cause the first actuator to touch the rotor between the first and second end points of the rotor, the first actuator being adapted to expand the area of the open interior of the body between the first and second end points of the rotor as the rotor rotates. A first section of the open interior of the body can be adapted to receive at least one gas entered through the intake valve between the first and second end points of the rotor. The second spring can cause the second actuator to touch the rotor between the first and second end points of the rotor, the second actuator being adapted to compress the at least one gas as the rotor rotates. The electric spark can be adapted to induce combustion of the compressed gas, and the first section of the open interior of the body can be adapted to exit exhaust gas through the exhaust valve. In this embodiment, the open interior of the body can be cylindrical in shape, and the rotor at its outer end points can define a cylindrical perimeter. The at least one gas can be air. The first actuator and the second actuator can be disposed about 180 degrees apart from each other inside the body. Each of the four end points can be disposed about 90 degrees apart from each other. An outer perimeter of the rotor from the first end point to the second end point can be substantially arc-shaped and can cause the adjacent outer perimeter of the first section of the open interior of the body to be substantially arc-shaped. The engine can further comprise a first actuator seal disposed on or at an outer tip of the first actuator such that the first actuator can be within millimeters or microns of touching the rotor between the first and second end points of the rotor, and a second actuator seal disposed on or at an outer tip of the second actuator such that the second actuator can be within millimeters or microns of touching the rotor between the first and second end points of the rotor. The four seals, the first actuator seal, and the second actuator seal can be apex seals or piezoelectric ceramic seals.

In yet another exemplary embodiment, the engine can be a rotary engine with external actuators, comprising combustion cavities integrated into the engine's central rotating rotor, and multiple cavities in a single rotor, allowing a complete combustion cycle to be completed in 360 degrees and providing high torque. The engine can comprise fixed rotor vanes that are not affected by centrifugal force when the rotor rotates, and since the vanes can be fixed to the rotor, they can have a simple mechanism. Seals can be integrated into the tips of the fixed rotor blades, enabling efficient operation, as the gap between the blade tip and the motor body can remain unchanged. The motor body and rotor can have cylindrical geometry, allowing for better sealing between the parts, reducing vibrations inherent to combustion and facilitating the manufacturing of its parts. External actuators can be positioned in a specific location, regulating the engine's internal combustion cycles by changing the volume of the spaces they create as the rotor rotates. The engine can further comprise piezoelectric seals on the tips of the rotor blades, piezoelectric seals on the tips of the actuators, and piezoelectric strips integrated into the motor body (stator).

All measurements, dimensions, amounts, sizes, shapes, percentages, configurations, securement or attachment mechanisms, numbers, ranges, values, percentages, materials, orientations, methods of manufacture, etc. discussed above or shown in the figures are merely by way of example and are not considered limiting and other measurements, dimensions, amounts, sizes, shapes, percentages, configurations, securement or attachment mechanisms, numbers, ranges, values, percentages, materials, orientations, methods of manufacture, etc. can be chosen and used and all are considered within the scope of the disclosure.

Dimensions of certain parts as shown in the drawings may have been modified and/or exaggerated for the purpose of clarity of illustration and are not considered limiting. Component values shown in the drawings, are merely examples of component values and part numbers that can be used, and the present invention is not considered limited to these specific component values and part numbers.

Unless feature(s), part(s), component(s), characteristic(s) or function(s) described in the specification or shown in the drawings for a claim element, claim step or claim term specifically appear in the claim with the claim element, claim step or claim term, then the inventor does not considered such feature(s), part(s), component(s), characteristic(s) or function(s) to be included for the claim element, claim step or claim term in the claim for examination purposes and when and if the claim element, claim step or claim term is interpreted or construed. Similarly, with respect to any “means for” elements in the claims, the inventor considers such language to require only the minimal amount of features, components, steps, or parts from the specification to achieve the function of the “means for” language and not all of the features, components, steps or parts describe in the specification that are related to the function of the “means for” language.

While the device has been described and disclosed in certain terms and has disclosed certain embodiments or modifications, persons skilled in the art who have acquainted themselves with the invention, will appreciate that it is not necessarily limited by such terms, nor to the specific embodiments and modification disclosed herein. Thus, a wide variety of alternatives, suggested by the teachings herein, can be practiced without departing from the spirit of the disclosure, and rights to such alternatives are particularly reserved and considered within the scope of the disclosure.

1. A rotary internal combustion engine comprising:
a body defining an open interior;
a rotor disposed inside the open interior of the body, the rotor having a plurality of end points, wherein each end point is configured to be proximate to an interior surface of the body;
at least one chamber defined between adjacent end points on an exterior surface of the rotor;
a first actuator disposed within the body;
a second actuator disposed within the body;
an intake valve configured to admit at least one gas into the at least one chamber;
an exhaust valve configured to discharge exhaust gas from the at least one chamber; and
an ignition source configured to induce combustion of a compressed gas within the at least one chamber;
wherein the first actuator is configured to separate an intake region from an exhaust region within the open interior; and
wherein the second actuator is configured to compress the at least one gas within the at least one chamber as the rotor rotates.

2. The engine of claim 1, wherein the open interior of the body is substantially cylindrical in shape and the rotor defines a substantially cylindrical outer perimeter at the plurality of end points.

3. The engine of claim 1, wherein the rotor comprises four end points, each end point disposed approximately 90 degrees apart from each adjacent end point.

4. The engine of claim 1, wherein the at least one chamber is substantially arc-shaped.

5. The engine of claim 1, wherein the plurality of end points comprise vanes that are monolithically formed as an integral part of the rotor.

6. The engine of claim 1, wherein the first actuator and the second actuator are disposed approximately 180 degrees apart from each other within the body.

7. The engine of claim 1, wherein at least one of the first actuator and the second actuator is coupled to a spring disposed external to the open interior of the body.

8. The engine of claim 1, further comprising at least one seal disposed on at least one of the plurality of end points, the at least one seal configured to maintain a gap between the at least one end point and the interior surface of the body.

9. A method of operating a rotary internal combustion engine, the method comprising:
rotating a rotor within a body defining an open interior, the rotor having a plurality of end points and at least one chamber defined between adjacent end points;
admitting at least one gas into the at least one chamber through an intake valve as the rotor rotates;
separating an intake region from an exhaust region within the open interior using a first actuator;
compressing the at least one gas within the at least one chamber using a second actuator as the at least one chamber moves past the second actuator during rotation of the rotor;
inducing combustion of the compressed gas within the at least one chamber using an ignition source, thereby generating a force configured to promote continued rotation of the rotor; and
discharging exhaust gas from the at least one chamber through an exhaust valve.

10. The method of claim 9, wherein the steps of admitting, compressing, inducing combustion, and discharging are completed within a single 360-degree rotation of the rotor.

11. The method of claim 9, wherein the rotor comprises a plurality of chambers, and wherein at least two of the plurality of chambers are simultaneously at different stages of a combustion cycle during rotation of the rotor.

12. The method of claim 9, further comprising sealing a gap between at least one of the plurality of end points and an interior surface of the body using at least one piezoelectric ceramic seal.

13. The method of claim 12, further comprising applying a voltage to the at least one piezoelectric ceramic seal to adjust a tolerance between the at least one end point and the interior surface of the body during operation.

14. The method of claim 12, further comprising generating electrical energy from interaction between a piezoelectric seal disposed on the at least one end point and a piezoelectric seal disposed on at least one of the first actuator and the second actuator.

15. A rotary engine system comprising:
a substantially cylindrical body defining an open interior;
a rotor disposed within the open interior of the body, the rotor comprising a plurality of end points and a plurality of arc-shaped chambers defined between adjacent end points, wherein the plurality of end points comprise vanes monolithically formed as an integral part of the rotor;
a first actuator and a second actuator each disposed within the body, each actuator coupled to a respective spring, the first actuator configured to separate an intake region from an exhaust region and the second actuator configured to form a wall within at least one of the plurality of arc-shaped chambers to compress a gas within at least one of the plurality of arc-shaped chambers, wherein the second actuator constantly changing such that the wall shrinks an internal area of the at least one of the plurality of arc-shaped chambers as the rotor rotates;
at least one seal disposed on at least one of the plurality of end points; and
an ignition source configured to induce combustion of the compressed gas.

16. The system of claim 15, wherein the at least one seal disposed on the least one of the plurality of end points is a piezoelectric seal and the device further comprising at least one piezoelectric seal disposed on a tip of at least one of the first actuator and the second actuator.

17. The system of claim 16, further comprising a control system configured to receive signals from the at least one piezoelectric seal on the tip of the first actuator and the second actuator and to adjust a tolerance between the rotor and the body based on the received signals.

18. The system of claim 16, wherein interaction between the at least one piezoelectric seal on the tip of the at least one actuator and the at least one piezoelectric seal on the at least one end point is configured to generate electrical energy via a direct piezoelectric effect.

19. The system of claim 15, further comprising at least one piezoelectric strip disposed on an interior surface of the substantially cylindrical body, the at least one piezoelectric strip configured to interact with the at least one seal on the at least one end point during rotation of the rotor.

20. The system of claim 15, wherein the respective springs are disposed external to the open interior of the body, and wherein the first actuator and the second actuator enter the open interior through slits in the body.
